(19) United States
(12) Patent Application Publication
(10) Pub. No.: US 2026/0255147 A1
(43) Pub. Date: Aug. 27, 2026

(54) ACCESS CONTROL OF 3G ROAMING SERVICES IN 5G STANDALONE NETWORK

(71) Applicant: DISH Wireless L.L.C., Englewood, CO (US)

(72) Inventors: Jaya Chandra Chikatmarla, Denver, CO (US); Kumar Anshuman, Bangalore (IN); Sruthi Nair, Aurora, CO (US); Mohammad Dawood Shahdad, Aurora, CO (US)

(21) Appl. No.: 19/063,661

(22) Filed: Feb. 26, 2025

(51) Int. Cl. H04W 8/12; H04W 60/04

(52) U.S. Cl. CPC H04W 8/12; H04W 60/04

(57) ABSTRACT

Technologies for enabling service access control in roaming of a fifth generation (5G) capable user equipment (UE) from a 5G home network to a third generation (3G) visited network are described. One method includes receiving, by a processing device in the 5G home network, from a mobile switching center (MSC) in the 3G visited network, a location update request, wherein location update request is originated by a request from the 5G capable user equipment (UE) to use a 3G network service of a plurality of 3G network services provided by the 3G visited network; and sending, by the processing device, to the MSC in the 3G visited network, an insert subscriber data message, wherein the insert subscriber data message comprises a subscriber service-accessing profile associated with the 5G capable UE, and wherein the MSC controls access of the 5G capable UE to the 3G network service according to the subscriber service-accessing profile.

### BACKGROUND

As the technology of cellular networks is highly complex and continuously develops, a previous generation (e.g., third generation (3G) cellular network) and a next generation (e.g., fifth generation (5G) new radio (NR) cellular network) may co-exist for a certain period of time. For example, 5G NR cellular networks have the promise to provide higher throughput, lower latency, and higher availability compared with previous global wireless standards. However, compatible utilization of 3G network and 5G NR may require further devolvement.

### BRIEF DESCRIPTION OF THE DRAWINGS

The present disclosure is illustrated by way of example, and not by way of limitation, in the figures of the accompanying drawings.

FIG. 1 is a block diagram of a system implementing access control of 3G roaming services for a 5G capable user equipment (UE) in 5G standalone network according to at least one embodiment.

FIG. 2 is a block diagram of a system including a roaming component that implements access control of 3G roaming services in 5G standalone network according to at least one embodiment.

FIG. 3 illustrates an example implementation for access control of 3G roaming services in 5G standalone network according to at least one embodiment.

FIG. 4 is a flow diagram of example method of implementing access control of 3G roaming services in 5G standalone network according to at least one embodiment.

FIG. 5 is a block diagram of an example computer system in which embodiments of the present disclosure can operate.

### DETAILED DESCRIPTION

Technologies for implementing access control of previous generation (e.g., 3G) roaming services in a next generation cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

There is a technology gap in current telecommunications networks where 5G capable user equipment (UE) roams from a 5G home network to a 3G visited network. Roaming can be defined as the ability for the UE to automatically make and receive voice calls, send and receive data, or access other services, including home data services, when travelling outside the geographical coverage area of the home network, by means of using a visited network. Roaming may need the support from mobility management, authentication, authorization, and billing procedures. For example, the customized applications for mobile network enhanced logic (CAMEL) is a standard used to enable the mobile UE to roam between different networks and is implemented in 3G network (e.g., global system for mobile communication (GSM) network). When a mobile UE attempts to make a call, it sends the request to mobile switching center (MSC) in the 3G network. The MSC then sends the request to intelligent network (e.g., service control point (SCP)) that queries the database of SCP. The SCP processes the query and generates a response, and then sends the response back to the MSC, indicating action(s) to be taken to make the call. For example, the action may be short code dialing over a virtual private network (VPN) where the mobile UE calls an internal extension telephone number but is, in fact, routed to the mobile UE which is roaming abroad. CAMEL can be used to control (e.g., bar) the access to the services (e.g., call) provided in the 3G network. However, CAMEL is not required to be implemented in a 5G standalone network. The 5G standalone network does not have the network hardware of 3G network such as MSC and intelligent network, because the 5G standalone network uses cellular infrastructures built specifically for 5G services by implementing 5G standards and protocols in the radio network and core network. Thus, additional cost may be required to equip the 5G standalone network with the network hardware of 3G network to implement CAMEL in 5G standalone network.

Aspects and embodiments of the present disclosure address the above and other deficiencies by providing a system that implements access control of roaming services for 5G capable UE that roams from a 5G home network to a 3G visited network. While a 5G capable UE is roaming from a 5G home network to a 3G visited network, the access of the 5G capable UE to the services in the 3G visited network can be controlled via a home location register (HLR) in the 5G home network. HLR in 5G network is a database that contains data regarding authorized subscribers, including information ranging from phone numbers to current location of the subscriber. This information can be updated each time the 5G capable UE is transferred to another location. Specifically, the HLR may include subscriber service-accessing profile, which provides information for controlling the access to services in the 3G network. In some implementations, the subscriber service-accessing profile can be factored on network policies or network conditions such as geographical locations, specific numbers, or time-of-day restrictions. In some implementations, the subscriber service-accessing profile can be used to control the access to service (e.g., bar the calls) that does not satisfy certain criteria regardless of the subscriber's individual preferences. For example, the subscriber service-accessing profile may have a priority higher than a priority of an individual setting of the 5G capable UE regarding the access of the 5G capable UE to the 3G network service. The subscriber service-accessing profile can be used as part of the location update procedure during roaming in the 3G visited network. Specifically, when roaming in the 3G visited network, the 5G capable UE can send a location update request to the radio access network (RAN) of 3G visited network to use a 3G network service. The RAN of 3G visited network may relay the location update request to MSC of 3G visited network (“visited MSC” or “VMSC”). The VMSC may send the location update request (e.g., in a GSM mobile application part (MAP) format) to the HLR in the 5G home network. Upon receiving the location update request, the HLR of the 5G home network (or a component of the 5G home network (e.g., the roaming component)) may generate insert subscriber data (ISD) message that includes a subscriber service-accessing profile associated with the 5G capable UE. The VMSC may return an insert subscriber data answer message that acknowledges the ISD message to the HLR of the 5G home network. The HLR of the 5G home network (or a component of the 5G home network (e.g., the roaming component)) may generate a location update response to acknowledge the location update request and send the location update response to the VMSC. As such, the VMSC may control the access of 5G capable UE to the 3G visited network service according to the subscriber service-accessing profile. This method can be completely software-based implantation on HLR of the 5G home network, and the subscriber service-accessing profile may be available via unified data management (UDM), which is a network function of the 5G home network to act as a front-end and serve essential services to the different network functions on request.

Aspects and embodiments of the present disclosure can provide access control of 3G roaming services in 5G standalone network without using CAMEL based intelligent network (SCP) on a 5G standalone network. Aspects and embodiments of the present disclosure can improve system performance and cost-efficiency between the 5G capable UE, 3G visited network, and the 5G home network, without the need to equip the 5G network with 3G network nodes. Aspects and embodiments of the present disclosure allows the 5G standalone network operators to have the control on barring of the services while subscribers (e.g., the subscribers without the roaming subscription) are roaming internationally in 3G network without using legacy GSM network nodes, which reduces overall cost in providing the service.

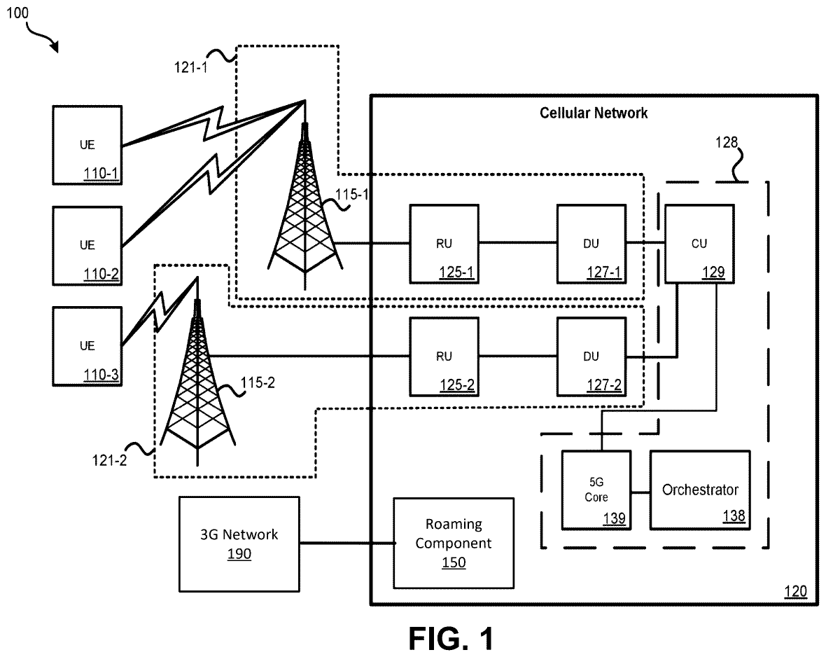

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

A container orchestration platform (e.g., Kubernetes) can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) (e.g., AMF 234) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating, updating, and removing protocol data unit (PDU) sessions, and managing session context with the user plane function (UPF) (e.g., manage UE context and network handovers between base stations).

User plane function (UPF) can be responsible for packet routing and forwarding, packet inspection, QoS handling, and external PDU sessions for interconnecting with a data network (DN) (e.g., data network) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

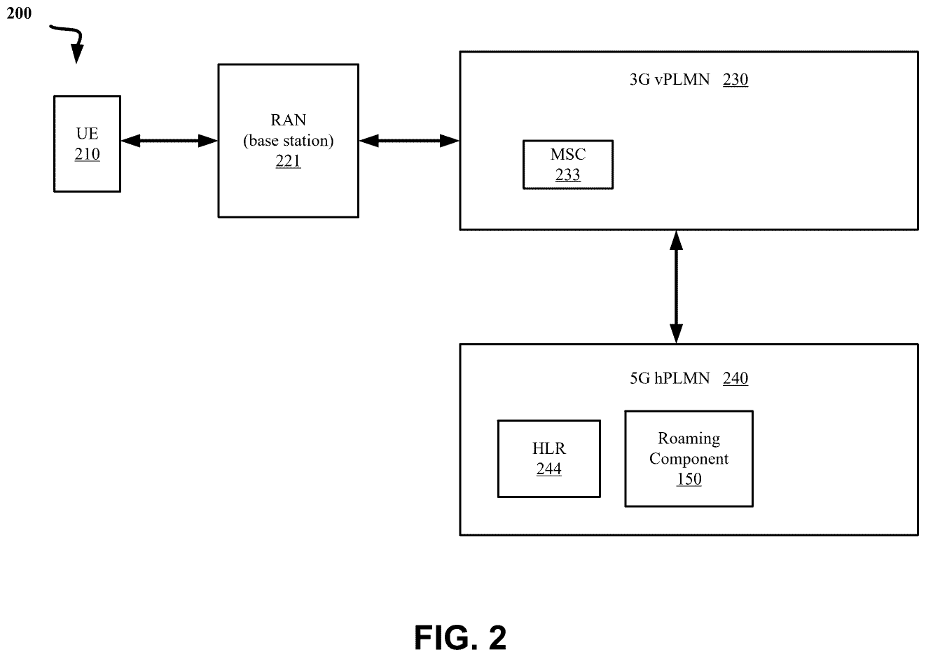

In some embodiments, the cellular network 120 includes a roaming component 150 that implements access control in 3G roaming services when the UE roams from the cellular network 120 (which is a 5G home network) to a 3G visited network (e.g., 3G network 190). In some embodiments, the roaming component 150 is part of the 5G core 139. Further details regarding the operations of the roaming component 150 are described below with reference to FIGS. 2-5.

FIG. 2 is a block diagram of example roaming from a 5G home network to a 3G visited network according to at least one embodiment. Referring to FIG. 2, a system 200 includes UE 210, radio access network (RAN) 221, a first core network 230, and a second core network 240 according to at least one embodiment. In at least one embodiment, the first core network 230 can be implemented as the 3G visited public land mobile network (vPLMN). In at least one embodiment, the second core network 240 can be implemented as the 5G home public land mobile network (hPLMN). In at least one embodiment, UE 210 has a 5G capability, which means that UE 210 is capable of connecting to 5G network and the previous generation network. In at least one embodiment, UE 210 uses 5G hPLMN as a home service, and visits 3G vPLMN for a roaming service.

The UE 210 can include an electronic device with wireless connectivity or cellular communication capability, including mobile computing device such as a mobile phone or handheld computing device, and non-mobile computing device. In at least one example, the UE 210 can include a 5G smartphone or a 5G cellular device that connects to the RAN 221 via a wireless connection. The UE 210 can include one of a number of UEs not depicted that are in communication with the RAN 221. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221.

Referring to FIG. 2, UE 210 connects the 3G vPLMN via the RAN 211 to the data network (not shown), and the data network can include the Internet, a local area network (LAN), a wide area network (WAN), a private data network, a wireless network, a wired network, or a combination of networks. The RAN 221 includes a radio unit (RU) for wirelessly communicating with UE 210. The RU may include one or more radio transceivers for wirelessly communicating with UE 210. The RU may include circuitry for converting signals sent to and from an antenna of a Base Station into digital signals for transmission over packet networks.

In some implementations, the RAN 221 may correspond with a 3G radio Base Station that connects user equipment to the core network 239. The 3G radio Base Station may be referred to as a Node B. In some implementations, the RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210. The RAN 221 can include a new-generation radio access network (NG-RAN) that uses the 5G NR interface. In some embodiments, the distributed unit (DU) and the centralized unit (CU) of the RAN 221 may be co-located with the RU. In other embodiments, the DU and the RRU may be co-located at a cell site and the centralized unit (CU) may be located within a local data center (LDC). The DU can include a logical node configured to provide functions for the radio link control (RLC) layer, the medium access control (MAC) layer, and the physical layer (PHY) layers. The centralized unit (CU) can be partitioned into a CU user plane portion (CU-UP) and a CU control plane portion (CU-CP). The CU-CP may perform functions related to a control plane, such as connection setup, mobility, and security. The CU-UP may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) can include a logical node configured to provide functions of the control plane part of the RRC and PDCP. The centralized unit for the user plane (CU-UP) can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more radio units (RUs) that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RU).

In some cases, the UE 210 may be capable of transmitting signals to and receiving signals from one or more RUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The 3G vPLMN 230 may include mobile switching center (MSC) 233. The MSC 233 may be used to route all mobile communications from the base station 221. The MSC 233 may be in charge of managing voice calls, short message service (SMS), and data services. The MSC 233 may manage call setup between subscribers and oversee both inter-BSC (Base Station Controller) handovers and inter-MSC handovers. When the UE 210 approaches the edge of its cell coverage, the MSC 233 may receive an inter-BSC handover request from BSC, and the MSC 233 may identify the appropriate adjacent BSC and executes a seamless transfer of the UE 210, ensuring continuous connectivity. The MSC 233 may cooperate with the HLR 244 to accommodate the dynamic mobility of the UE 210. Leveraging the HLR 244, the MSC 233 may ensure accurate call routing and uninterrupted connectivity as the UE 210 (e.g., mobile subscribers) traverse different cellular areas.

The 5G hPLMN 240 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The 5G hPLMN 240 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) (e.g., AMF 234), the session management function (SMF), and the user plane function (UPF). The AMF may interface with UE 210, act as a single-entry point for a UE connection, and perform mobility management, registration management, and connection management between data network and UE 210. The AMF may interface with the SMF to track user sessions. The AMF may interface with a network slice selection function (NSSF) to select network slice instances for user equipment. When user equipment is leaving a first coverage area and entering a second coverage area, the AMF may be responsible for coordinating the handoff between the coverage areas whether the coverage areas are associated with the same radio access network or different radio access networks. The SMF may perform session management, user plane selection, and Internet Protocol (IP) address allocation. After the Access Gateway Function (AGF) authenticates the subscriber and establishes a protocol data unit (PDU) session, the SMF may select the UPF for the subscriber.

The UPF may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF may serve as an ingress and egress point for user plane traffic and provide anchored mobility support for user equipment. The UPF may be implemented as a software process or application running within a virtualized infrastructure or a cloud-based compute and storage infrastructure.

The UPF may transfer downlink data received from the data network to the UE 210, via the RAN 221 and/or transfer uplink data received from the UE 210 to the data network via the RAN 221. An uplink can include a radio link though which UE 210 transmits data and/or control signals to the RAN 221. A downlink can include a radio link through which the RAN 221 transmits data and/or control signals to the UE 210.

Uplink packets arriving from the RAN 221 may use a general packet radio service (GPRS) tunneling protocol (or GTP) to reach the UPF. The GPRS tunneling protocol for the user plane may support multiplexing of traffic from different PDU sessions by tunneling user data over the interface N3 between the RAN 221 and the UPF. The UPF may remove the packet headers belonging to the GTP tunnel before forwarding the user plane packets towards the data network. As the UPF may provide connectivity towards other data networks in addition to the data network, the UPF ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate RAN 221. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the 5G vPLMN 220. To establish user plane connectivity from the UE 210 to the data network, the AMF 234 that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, an application function (AF) providing application services, and a short message service function (SMSF) providing messaging services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The 5G hPLMN 240 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 220. In some cases, the 5G network 220 may support customized policy configuration and enforcement between network slices per service level agreements (SLAs) within the RAN 221. User equipment, such as UE 210, may connect to multiple network slices at the same time (e.g., eight different network slices). In some cases, the 5G network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The 5G hPLMN 240 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

The 5G hPLMN 240 may include a home location register (HLR) 244 and a roaming component 150. In some implementations, the roaming component 150 may be included in the HLR 244. The HLR 244 may be a database that contains data regarding authorized subscribers, including information such as phone numbers, service subscriptions, and/or current location of the subscriber. This information can be updated each time the UE 210 is transferred to another location. The HLR 244 may be used to identify their last known location of the 5G capable UE. In some implementations, the HLR 244 may be used to identify the mobile switching center (MSC) that are used by the UE 210. In some implementations, the HLR 244 may help with authentication and service provisioning in the visited network (e.g., the 3G vPLMN 230). The HLR 244 may verify the subscriber's identity and check their subscribed services to provide the correct services, such as voice calls, SMS, and data.

The roaming component 150 may receive a location update request associated with the UE 210 and, in response, generate and send insert subscriber data that includes a subscriber service-accessing profile associated with the UE 210, where the subscriber service-accessing profile associated with the UE 210 provides information for controlling the access of the UE 210 to services in the 3G network and can be factored on network policies or network conditions, such as geographical location of UE, specific number of services, time-of-day restrictions, etc.

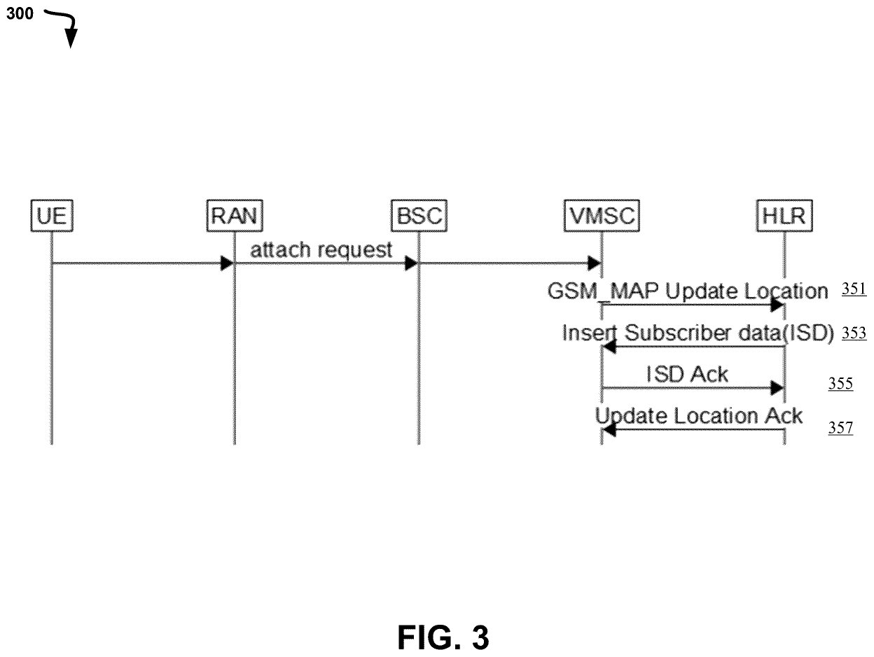

FIG. 3 illustrates example implementations for access control of 3G roaming services in 5G standalone network. Using FIG. 3 as an illustrative example, the UE (e.g., UE 210) may be responsible for detecting location area codes associated with the RAN that can be used by the UE. When the UE finds that the location area code is different from its last update, it performs a location update procedure by sending, to the RAN, a location update request, together with its previous location, and its temporary international mobile subscriber identity (IMSI) (which can be referred to as attach request in IMSI attachment procedure). As each RAN covers a small geographical area which is part of a uniquely identified location area (identified by the location area code), the location update request may inform RAN whenever it moves from one location area to another location area. The RAN may relay, via the base station controller (BSC), the location update request to visited MSC (VMSC) (e.g., MSC 233 in the 3G vPLMN 230). The VMSC (e.g., MSC 233) may send the location update request (e.g., in a GSM mobile application part (MAP) format) to the HLR in the home network (e.g., HLR 244). For example, the roaming component 150 of the HLR (e.g., HLR 244) may receive the location update request 351 from the VMSC (e.g., MSC 233), and generate insert subscriber data (ISD) message 353 that includes a subscriber service-accessing profile associated with the UE (e.g., UE 210).

The subscriber service-accessing profile associated with the UE (e.g., UE 210) may provide information for controlling the access of the UE to services in the visited network (e.g., 3G vPLMN 230) and can be factored on network policies or network conditions, such as the geographical location of UE, the specific number of services, the time-of-day restrictions, etc. In one example, the subscriber service-accessing profile may define a first set of services in the visited network (e.g., 3G vPLMN 230) allowed in a ranged area of a first geographical location, and/or define a second set of services in the visited network (e.g., 3G vPLMN 230) not allowed in a ranged area of a second geographical location. In another example, the subscriber service-accessing profile may define a third set of services in the visited network (e.g., 3G vPLMN 230) allowed in a specific number (e.g., number X services allowed), and/or define a fourth set of services in the visited network (e.g., 3G vPLMN 230) not allowed in a specific number (e.g., number Y services not allowed). In yet another example, the subscriber service-accessing profile may define a fifth set of services in the visited network (e.g., 3G vPLMN 230) allowed in a specific time (e.g., services allowed during morning time of weekdays), and/or define a sixth set of services in the visited network (e.g., 3G vPLMN 230) not allowed in a specific time (e.g., services not allowed during nighttime of weekends).

In some implementations, the subscriber service-accessing profile may have a priority higher than a priority of an individual setting of the UE (e.g., UE 210) regarding the access of the 5G capable UE to the 3G network service. For example, the subscriber service-accessing profile may define a specific service in the visited network (e.g., 3G vPLMN 230) not allowed in a specific time, while the individual setting of the UE (e.g., UE 210) may define the specific service allowed in the specific time, in such case, the subscriber service-accessing profile may override the individual setting of the UE (e.g., UE 210) regarding the specific service in the specific time.

In some implementations, the HLR (e.g., HLR 244) may be part of unified data repository (UDR). UDR may be a database for the home network (e.g., 5G hPLMN 240) and be used to store subscription data, policy data, structured data for exposure, and application data. The subscriber service-accessing profile may be available via unified data management (UDM), which acts as a front-end and serves essential services to the different network functions on request. UDR may be used by the network functions to store their relative data and retrieve the data through request messages.

The roaming component 150 of the HLR (e.g., HLR 244) may send, to the VMSC (e.g., MSC 233), the insert subscriber data (ISD) message 353 that includes a subscriber service-accessing profile associated with the UE (e.g., UE 210). The VMSC (e.g., MSC 233) may return an insert subscriber data answer message 355 that acknowledges the ISD message 353 to the HLR (e.g., HLR 244). The roaming component 150 of the HLR (e.g., HLR 244) may generate a location update response 357 to acknowledge the location update request 351 and send the location update response 357 to the VMSC (e.g., MSC 233). In some implementations, the roaming component 150 may be in charge of real-time pre-paid billing, account management, and call setup between subscribers.

In some implementations, the UE (e.g., UE 210) may store the current location area code in a list of recently used current location area codes, which can be used to avoid unnecessary IMSI attachment procedures. In some implementations, when the UE (e.g., UE 210) is switched on or off, the UE may need to perform an IMSI attach or IMSI detach location update procedure. In some implementations, the UE (e.g., UE 210) may need to regularly report its location at a preset time interval to perform a periodic location update procedure. In some implementations, the UE (e.g., UE 210) may need to reselect coverage from a cell in a different location area to perform a location update procedure because of signal fade.

In some implementations, a system (e.g., system 100 in FIG. 1, system 200 in FIG. 2, or system 300 in FIG. 3) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, system 200 in FIG. 2, or system 300 in FIG. 3) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a roaming component (e.g., the roaming component 150 of FIGS. 1-3).

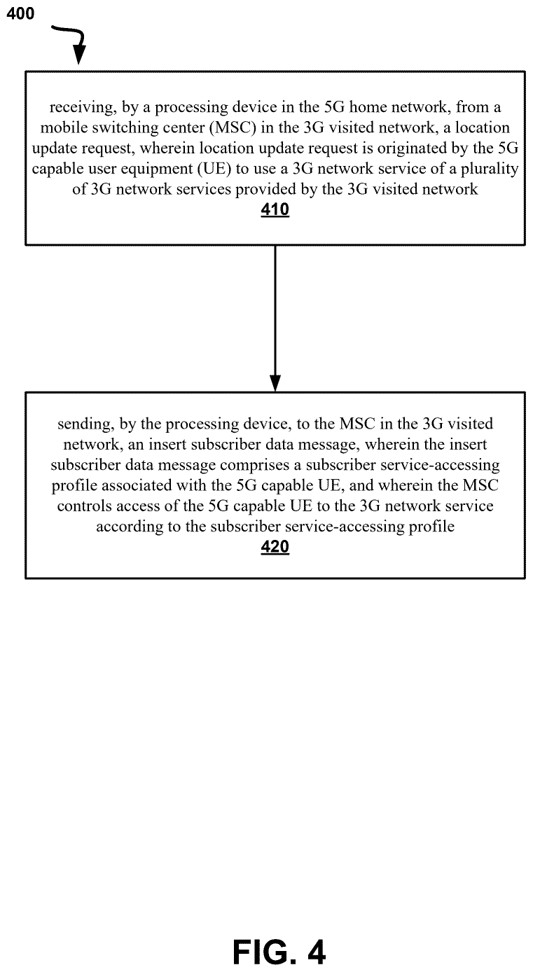

FIG. 4 is a flow diagram of method 400 of implementing access control of precedent-generation (e.g., 3G) roaming services in a subsequent-generation (e.g., 5G) standalone network according to at least one embodiment. The method 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 400 is performed by the system 100 of FIG. 1. In one embodiment, the method 400 is performed by the roaming component 150 of FIGS. 1-3.

Referring to FIG. 4, at operation 410, the processing logic in the subsequent-generation (e.g., 5G) home network may receive, from a mobile switching center (MSC) in the precedent-generation (e.g., 3G) visited network, a location update request, wherein location update request is originated by a request from the subsequent-generation (e.g., 5G) capable user equipment (UE) to use a precedent-generation (e.g., 3G) network service of a plurality of precedent-generation (e.g., 3G) network services provided by the precedent-generation (e.g., 3G) visited network.

At operation 420, the processing logic in the subsequent-generation (e.g., 5G) home network may send, to the MSC in the precedent-generation (e.g., 3G) visited network, an insert subscriber data message, wherein the insert subscriber data message comprises a subscriber service-accessing profile associated with the subsequent-generation (e.g., 5G) capable UE, and wherein the MSC controls access of the subsequent-generation (e.g., 5G) capable UE to the precedent-generation (e.g., 3G) network service according to the subscriber service-accessing profile.

In some implementations, the processing logic in the subsequent-generation (e.g., 5G) home network may receive, from the MSC in the precedent-generation (e.g., 3G) visited network, a message that acknowledges the insert subscriber data message. In some implementations, the processing logic in the subsequent-generation (e.g., 5G) home network may send, to the MSC in the precedent-generation (e.g., 3G) visited network, a location update response, wherein the location update response acknowledges location updating responsive to the location update request.

In some implementations, the processing device comprises a home location register (HLR) in the subsequent-generation (e.g., 5G) home network. In some implementations, the subscriber service-accessing profile is factored on one or more network policies or network conditions. In some implementations, the subscriber service-accessing profile is factored on at least one of: a geographical location of the UE, a number of services, or a time-of-day restriction. In some implementations, the subscriber service-accessing profile has a priority higher than a priority of an individual setting of the subsequent-generation (e.g., 5G) capable UE regarding the access of the subsequent-generation (e.g., 5G) capable UE to the precedent-generation (e.g., 3G) network service. In some implementations, the subscriber service-accessing profile is retrieved via a unified data management (UDM) in the subsequent-generation (e.g., 5G) home network.

Although the 5G home network and the 3G visited network are illustrated as examples, any combination of the subsequent-generation home network and the precedent-generation visited network is applicable here, such as 5G home network/4G visited network, 6G home network/3G visited network, 6G home network/5G visited network, etc. The UE is the subsequent-generation capable UE that is capable to use the subsequent-generation network and the precedent-generation network.

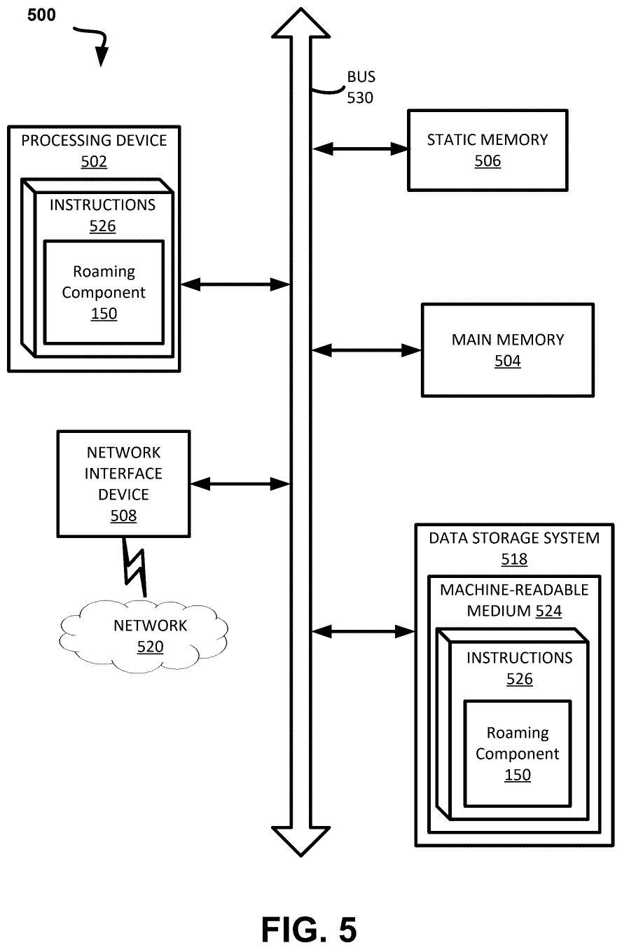

FIG. 5 illustrates an example machine of a computer system 500 within which a set of instructions, for causing the machine to perform any one or more of the methodologies discussed herein, can be executed. In some embodiments, the computer system 500 can be used to perform the operations of a controller (e.g., to execute an operating system to perform operations corresponding to the validation component 150 of FIGS. 1-2). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520. The network 520 may correspond to the cellular network 120 of FIG. 1, or the 5G network 220 of FIG. 2.

The data storage system 518 can include a machine-readable storage medium 524 (also known as a computer-readable medium or a non-transitory computer-readable storage medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The processing device 502, the network interface 508, and the network 520 can correspond to the system 100 of FIG. 1, or the system 200 of FIG. 2.

In one embodiment, the instructions 526 include instructions to implement functionality corresponding to the roaming component 150 of FIGS. 1-2. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of enabling service access control in roaming of a fifth generation (5G) capable user equipment (UE) from a 5G home network to a third generation (3G) visited network, the method comprising:
receiving, by a processing device in the 5G home network, from a mobile switching center (MSC) in the 3G visited network, a location update request, wherein location update request is originated by a request from the 5G capable user equipment (UE) to use a 3G network service of a plurality of 3G network services provided by the 3G visited network; and
sending, by the processing device, to the MSC in the 3G visited network, an insert subscriber data message, wherein the insert subscriber data message comprises a subscriber service-accessing profile associated with the 5G capable UE, and wherein the MSC controls access of the 5G capable UE to the 3G network service according to the subscriber service-accessing profile.

2. The method of claim 1, further comprising:
receiving, from the MSC in the 3G visited network, a message that acknowledges the insert subscriber data message; and
sending, to the MSC in the 3G visited network, a location update response, wherein the location update response acknowledges location updating responsive to the location update request.

3. The method of claim 1, wherein the processing device comprises a home location register (HLR) in the 5G home network.

4. The method of claim 1, wherein the subscriber service-accessing profile is factored on one or more network policies or network conditions.

5. The method of claim 1, wherein the subscriber service-accessing profile is factored on at least one of: a geographical location of the UE, a number of services, or a time-of-day restriction.

6. The method of claim 1, wherein the subscriber service-accessing profile has a priority higher than a priority of an individual setting of the 5G capable UE regarding the access of the 5G capable UE to the 3G network service.

7. The method of claim 1, wherein the subscriber service-accessing profile is retrieved via a unified data management (UDM) in the 5G home network.

8. A computing system to facilitate a cellular network, the computing system comprising:
one or more processing devices; and
memory communicatively coupled with and readable by the one or more processing devices and having stored therein processor-readable instructions which, when executed by the one or more processing devices in a subsequent-generation home network, cause the one or more processing devices to perform operations comprising:
receiving, from a mobile switching center (MSC) in a precedent-generation visited network, a location update request, wherein location update request is originated by a request from a subsequent-generation capable user equipment (UE) to use a precedent-generation network service of a plurality of precedent-generation network services provided by the precedent-generation visited network; and
sending, to the MSC in the precedent-generation visited network, an insert subscriber data message, wherein the insert subscriber data message comprises a subscriber service-accessing profile associated with the subsequent-generation capable UE, and wherein the MSC controls access of the subsequent-generation capable UE to the precedent-generation network service according to the subscriber service-accessing profile.

9. The computing system of claim 8, wherein the operations further comprise:
receiving, from the MSC in the precedent-generation visited network, a message that acknowledges the insert subscriber data message; and
sending, to the MSC in the precedent-generation visited network, a location update response, wherein the location update response acknowledges location updating responsive to the location update request.

10. The computing system of claim 8, wherein the one or more processing devices comprise a home location register (HLR) in the subsequent-generation home network.

11. The computing system of claim 8, wherein the subscriber service-accessing profile is factored on one or more network policies or network conditions.

12. The computing system of claim 8, wherein the subscriber service-accessing profile is factored on at least one of: a geographical location of the UE, a number of services, or a time-of-day restriction.

13. The computing system of claim 8, wherein the subscriber service-accessing profile has a priority higher than a priority of an individual setting of the subsequent-generation capable UE regarding the access of the subsequent-generation capable UE to the precedent-generation network service.

14. The computing system of claim 8, wherein the subscriber service-accessing profile is retrieved via a unified data management (UDM) in the subsequent-generation home network.

15. One or more non-transitory, computer-readable storage media having computer-readable instructions thereon which, when executed by one or more processing devices, cause the one or more processing devices in a subsequent-generation home network to perform operations comprising:
receiving, from a mobile switching center (MSC) in a precedent-generation visited network, a location update request, wherein location update request is originated by a request from a subsequent-generation capable user equipment (UE) to use a precedent-generation network service of a plurality of precedent-generation network services provided by the precedent-generation visited network; and
sending, to the MSC in the precedent-generation visited network, an insert subscriber data message, wherein the insert subscriber data message comprises a subscriber service-accessing profile associated with the subsequent-generation capable UE, and wherein the MSC controls access of the subsequent-generation capable UE to the precedent-generation network service according to the subscriber service-accessing profile.

16. The one or more non-transitory, computer-readable storage media of claim 15, wherein the operations further comprise:
receiving, from the MSC in the precedent-generation visited network, a message that acknowledges the insert subscriber data message; and
sending, to the MSC in the precedent-generation visited network, a location update response, wherein the location update response acknowledges location updating responsive to the location update request.

17. The one or more non-transitory, computer-readable storage media of claim 15, wherein the one or more processing devices comprise a home location register (HLR) in the subsequent-generation home network.

18. The one or more non-transitory, computer-readable storage media of claim 15, wherein the subscriber service-accessing profile is factored on one or more network policies or network conditions.

19. The one or more non-transitory, computer-readable storage media of claim 15, wherein the subscriber service-accessing profile is factored on at least one of: a geographical location of the UE, a number of services, or a time-of-day restriction.

20. The one or more non-transitory, computer-readable storage media of claim 15, wherein the subscriber service-accessing profile is retrieved via a unified data management (UDM) in the subsequent-generation home network.
